(19) United States
(12) Patent Application Publication
(10) Pub. No.: US 2024/0292896 A1
(43) Pub. Date: Sep. 5, 2024

(54) HEATING ASSEMBLY AND CIGARETTE DEVICE INCLUDING HEATING ASSEMBLY

(71) Applicant: SHENZHEN FIRST UNION TECHNOLOGY CO., LTD., Shenzhen City, Guangdong Province (CN)

(72) Inventors: WEI CHEN, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/574,022

(22) PCT Filed: Jun. 23, 2022
(86) PCT No.: PCT/CN2022/100842

§ 371 Date: Dec. 23, 2023

(30) Foreign Application Priority Data
Jun. 23, 2021 (CN) 202110695262.4

(51) Int. Cl. A24F 40/46; A24F 40/51

(52) U.S. Cl. CPC A24F 40/46; A24F 40/51

(57) ABSTRACT

This application relates to the field of cigarette devices, and provides a heating assembly and a cigarette device including the heating assembly. The heating assembly includes: a heater, configured to heat an aerosol-forming substrate to generate an aerosol; a temperature measuring element, configured to sense a temperature of the heater; and a fixing base, configured to fix an end of the heater, where the fixing base includes a support portion, and the support portion is configured to hold the temperature measuring element, to enable the temperature measuring element to be close to or in contact with a preset position on a surface of the heater. The temperature measuring element is held through the support portion of the fixing base, which ensures the stability of the position of the temperature measuring element, improves the reliability and consistency of temperature data collection, and facilitates effective control of the cigarette device.

### CROSS-REFERENCE TO RELATED APPLICATIONS

This application claims priority to Chinese Patent Application No. 202110695262.4, filed with the China National Intellectual Property Administration on Jun. 23, 2021 and entitled “HEATING ASSEMBLY AND CIGARETTE DEVICE INCLUDING HEATING ASSEMBLY”, which is incorporated herein by reference in its entirety.

### TECHNICAL FIELD

This application relates to the field of cigarette devices, and in particular, to a heating assembly and a cigarette device including the heating assembly.

### BACKGROUND

During use of smoking items such as cigarettes and cigars, tobacco is burnt to generate smoke. Attempts have been made to provide substitutes for these tobacco-burning items by producing products that release compounds without burning. An example of such a product is a so-called heat-not-burn product which releases a compound by heating instead of burning tobacco.

For an existing low-temperature heat-not-burn cigarette device, temperature data of a heater needs to be collected through an external temperature measuring element to control a temperature of the heater. The stability of a position of the temperature measuring element needs to be ensured. Otherwise, it is very easy to cause the collected temperature data to be inaccurate and the temperature of the heater of the cigarette device cannot be effectively controlled. Therefore, how to fix the temperature measuring element and ensure the stability of the position of the temperature measuring element is a main focus of existing cigarette device manufacturers.

### SUMMARY

This application provides a heating assembly and a cigarette device including the heating assembly, aiming at how to fix a temperature measuring element and ensure the stability of a position of the temperature measuring element.

An aspect of this application provides a heating assembly, including:
a heater, configured to heat an aerosol-forming substrate to generate an aerosol;
a temperature measuring element, configured to sense a temperature of the heater; and
a fixing base, configured to fix an end of the heater, where the fixing base includes a support portion, and the support portion is configured to hold the temperature measuring element, to enable the temperature measuring element to be close to or in contact with a preset position on a surface of the heater.

Another aspect of this application provides a cigarette device, including the foregoing heating assembly.

According to the heating assembly and the cigarette device including the heating assembly provided in this application, the temperature measuring element is held through the support portion of the fixing base, which ensures the stability of the position of the temperature measuring element, improves the reliability and consistency of temperature data collection, and facilitates effective control of the cigarette device.

### BRIEF DESCRIPTION OF THE DRAWINGS

One or more embodiments are exemplarily described with reference to the corresponding figures in the accompanying drawings, and the descriptions do not constitute a limitation to the embodiments. Components in the accompanying drawings that have same reference numerals are represented as similar components, and unless otherwise particularly stated, the figures in the accompanying drawings are not drawn to scale.

FIG. 1 is a schematic diagram of a cigarette device according to an implementation of this application;

FIG. 2 is a schematic diagram of a cigarette device and an aerosol-generating product according to an implementation of this application;

FIG. 3 is a schematic diagram of a heating assembly according to an implementation of this application;

FIG. 4 is a schematic exploded view of a heating assembly according to an implementation of this application;

FIG. 5 is a schematic cross-sectional diagram of a heating assembly according to an implementation of this application;

FIG. 6 is a schematic diagram of a heater according to an implementation of this application;

FIG. 7 is a schematic diagram of another heater according to an implementation of this application;

FIG. 8 is a schematic diagram from another perspective of another heater according to an implementation of this application;

FIG. 9 is a schematic diagram of an electrode connector according to an implementation of this application;

FIG. 10 is a schematic diagram of a lower fixing base according to an implementation of this application;

FIG. 11 is a schematic diagram from another perspective of a lower fixing base according to an implementation of this application;

FIG. 12 is a schematic cross-sectional diagram of a lower fixing base according to an implementation of this application; and

FIG. 13 is a schematic diagram of a temperature measuring element according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

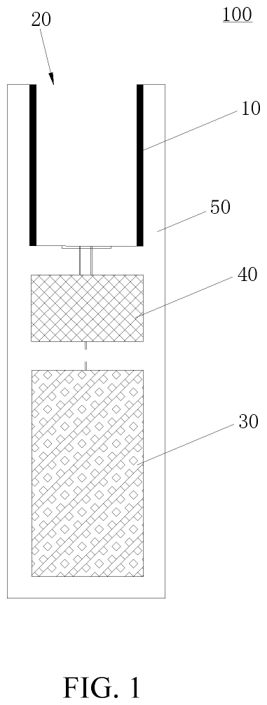

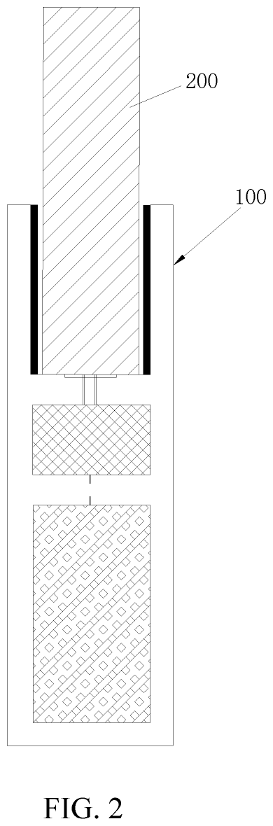

FIG. 1 and FIG. 2 show a cigarette device 100 according to an implementation of this application, including a heating assembly 10, a chamber 20, a battery cell 30, a circuit 40, and a housing assembly 50. The heating assembly 10, the chamber 20, the battery cell 30, and the circuit 40 are all arranged in the housing assembly 50.

The heating assembly 10 is configured to heat an aerosol-forming substrate to generate an inhalable aerosol.

The chamber 20 is configured to receive the aerosol-forming substrate.

The aerosol-forming substrate is a substrate that can release a volatile compound that can form an aerosol. The volatile compounds may be released by heating the aerosol-forming substrate. The aerosol-forming substrate may be solid, or liquid, or components including solid and liquid. The aerosol-forming substrate may be carried on a carrier or a support through absorption, coating, impregnation, or other manners. The aerosol-forming substrate may conveniently be a part of the aerosol-generating product 200.

The battery cell 30 provides power for operating the cigarette device 100. For example, the battery cell 30 can provide power for heating by the heating assembly 10. In addition, the battery cell 30 can provide power required to operate other elements provided in the cigarette device 100. The battery cell 30 may be a rechargeable battery or a disposable battery.

The circuit 40 can control the overall operation of the cigarette device 100. The circuit 40 not only controls the operation of the battery cell 30 and the heating assembly 10, but also controls the operation of other elements in the cigarette device 100. For example, the circuit 40 obtains information about the temperature of the heating assembly 10 sensed by a temperature measuring element 109, and controls the power supplied by the battery cell 30 to the heating assembly 10 according to the information.

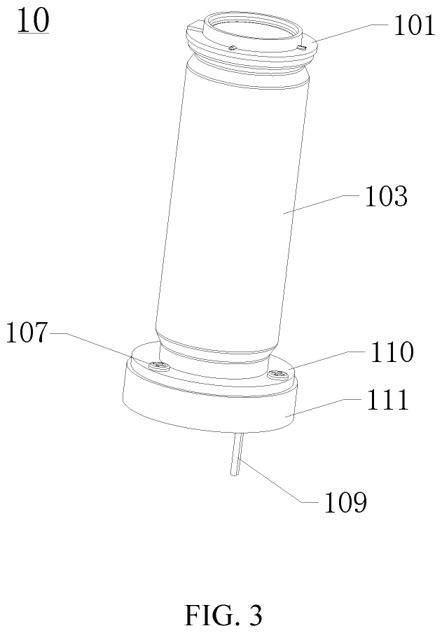

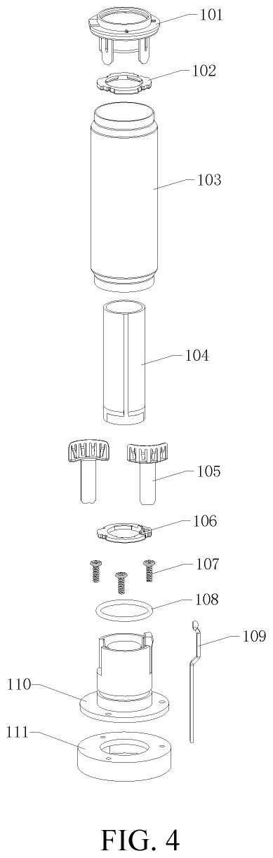

FIG. 3 to FIG. 5 show a heating assembly according to an implementation of this application. The heating assembly 10 includes an upper fixing base 101, an upper sealing member 102, a sleeve pipe 103, a heater 104, an electrode connector 105, a lower sealing member 106, a fastener 107, a sealing ring 108, a temperature measuring element 109, a lower fixing base 110, and a base 111.

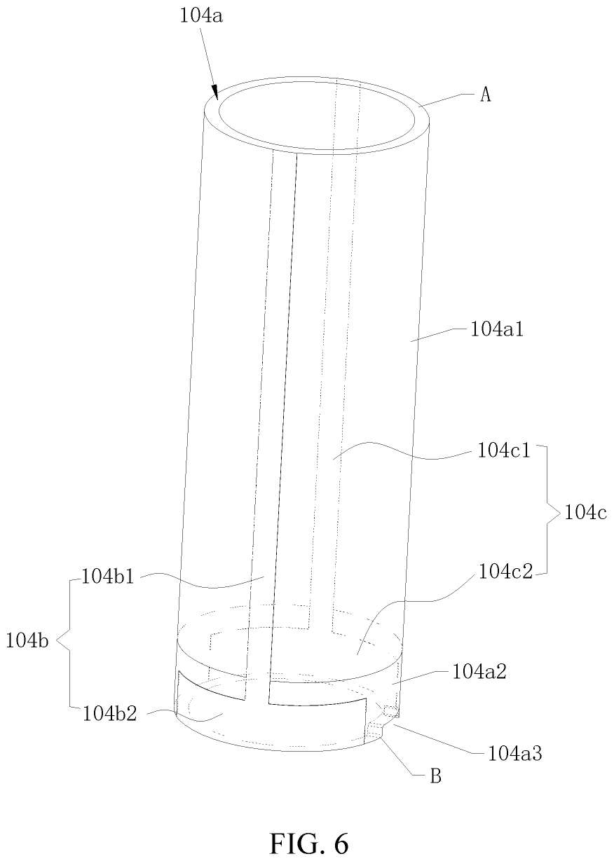

FIG. 6 shows a heater 104 according to an implementation of this application. The heater 104 includes:
a base body 104a, provided with a chamber inside configured to accommodate the aerosol-forming substrate.

Specifically, the base body 104a includes a near end A, a far end B, and a surface extending between the near end A and the far end B. The base body 104a is hollow and is provided with the chamber inside configured to accommodate the aerosol-forming substrate. The base body 104a may be in a shape of a cylinder, a prism, or another column. The base body 104a is preferably cylindrical, and the chamber is a cylindrical hole that runs through a middle portion of the base body 104a. An inner diameter of the hole is slightly greater than an outer diameter of the aerosol-generating product 200, so that it is convenient to place the aerosol-generating product 200 in the chamber for heating.

The base body 104a may be made of high temperature resistant and transparent materials such as quartz glass, ceramics, or mica, or other materials with high infrared transmittance, such as: high temperature resistant materials with an infrared transmittance of more than 95%, which are not limited herein specifically.

An electric infrared heating layer is formed on a surface of the base body 104a. The electric infrared heating layer may be formed on an outer surface of the base body 104a, or may be formed on an inner surface of the base body 104a.

In this example, the outer surface of the base body 104a includes a coating region 104a1 and a non-coating region 104a2. The non-coating region 104a2 is arranged adjacent to the far end B of the base body 104a. Generally, a length of the non-coating region 104a2 in an axial direction ranges from 1 mm to 2 mm. The electric infrared heating layer is formed on the coating region 104a1 of the outer surface of the base body 104a. The electric infrared heating layer receives the power provided by the battery cell 30 to generate heat, and then generates an infrared ray of a specified wavelength, such as: an 8 μm to 15 μm far infrared ray.

An electrode 104 includes a first electrode 104b and a second electrode 104c spaced apart on the base body 104a, configured to feed the power provided by the battery cell 30 to the electric infrared heating layer. At least a part of each of the first electrode 104b and the second electrode 104c is electrically connected to the electric infrared heating layer, to enable the current to flow from one electrode to the other electrode via the electric infrared heating layer.

In this example, the first electrode 104b and the second electrode 104c are conductive coatings. The conductive coating may be a metal coating or a conductive tape. The metal coating may include silver, gold, palladium, platinum, copper, nickel, molybdenum, tungsten, niobium, or an alloy material of the above metal.

The first electrode 104b and the second electrode 104c are symmetrically arranged along a central axis of the base body 104a. Specifically:

The first electrode 104b includes a coupling portion 104b2 extending in a circumferential direction of the base body 104a and a strip portion 104b1 extending in an axial direction from the coupling portion 104b2 toward the near end A. The coupling portion 104b2 is arranged in the non-coating region 104a2 of the outer surface of the base body 104a. A part of the strip portion 104b1 is located in the coating region 104a1 to form an electrical connection to the electric infrared heating layer.

The second electrode 104c includes a coupling portion 104c2 extending in the circumferential direction of the base body 104a and a strip portion 104cl extending in an axial direction from the coupling portion 104c2 toward the near end A. The coupling portion 104c2 is arranged in the non-coating region 104a2 of the outer surface of the base body 104a. A part of the strip portion 104cl is located in the coating region 104a1 to form an electrical connection to the electric infrared heating layer.

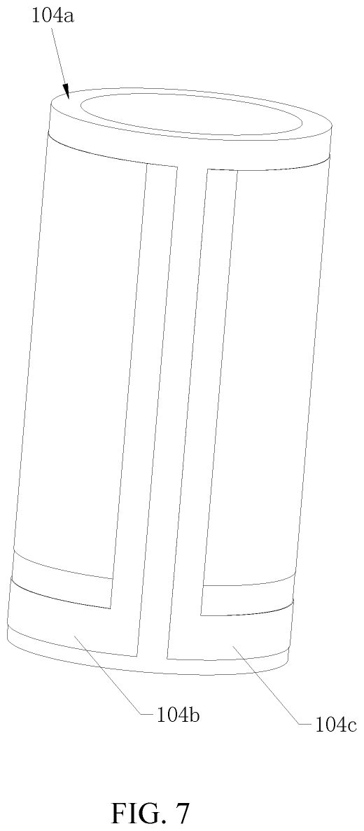

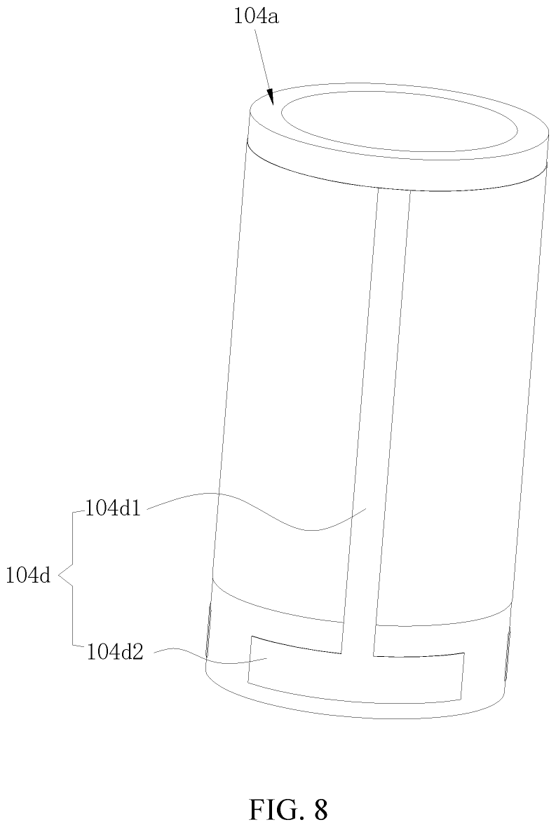

FIG. 7 and FIG. 8 show another heater according to an implementation of this application. Different from FIG. 6, the electrode further includes a third electrode 104d spaced apart on the base body 104a, that is, the first electrode 104b, the second electrode 104c, and the third electrode 104d are all spaced apart from each other. The first electrode 104b and the second electrode 104c are both positive electrodes, and the third electrode 104d is a common negative electrode.

The third electrode 104d includes a coupling portion 104d2 arranged in the non-coating region 104a2, and a strip portion 104dl extending axially from the coupling portion 104d2 toward the near end A.

The coupling portion 104b2, the coupling portion 104c2, and the coupling portion 104d2 are all spaced apart in the non-coating region 104a2 and located at the far end B of the base body 104a. The strip portion 104b1, the strip portion 104cl, and the strip portion 1151 partition the electric infrared heating layer into two independent heating regions in the circumferential direction of the base body 104a. After the coupling portion 104b2, the coupling portion 104c2, and the coupling portion 104d2 are coupled to the battery cell 30, heating is started by controlling the two independent heating regions, and different regions of the aerosol-forming substrate can be heated.

It should be noted that, the foregoing segmented heating is not limited to segments in the circumferential direction. In another example, upper and lower segments are also feasible.

It should be further noted that in the examples of FIG. 3 to FIG. 8, each heater 104 is an infrared heater. In another example, the heater 104 may adopt a heating method such as resistance heating, electromagnetic heating, or the like, which is also feasible. For ease of description, the following examples are all described based on the infrared heaters in FIG. 3 to FIG. 8.

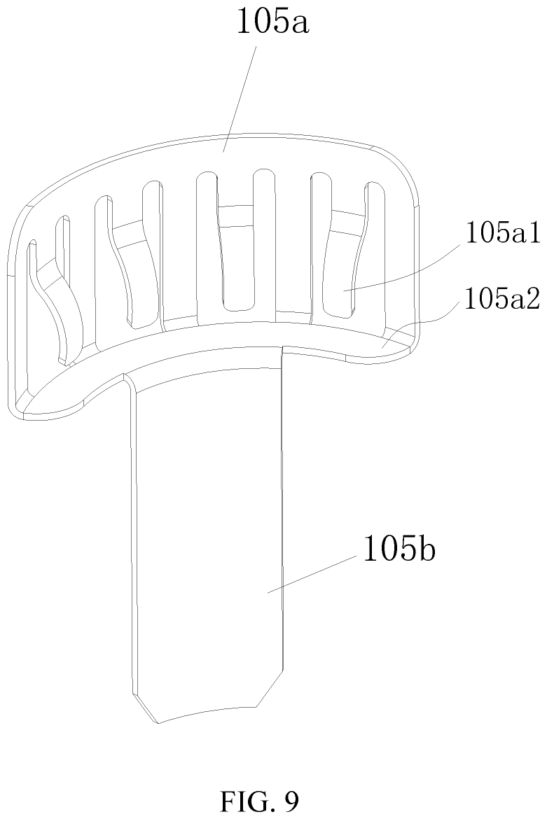

Understanding is performed with reference to FIG. 3 to FIG. 6 and FIG. 9. The cigarette device 100 includes two electrode connectors 105, and the two electrode connectors 105 are connected to the first electrode 104b and the second electrode 104c in one-to-one correspondence. The electrode connector 105 electrically connected to the first electrode 104b is taken as an example below for description.

The electrode connector 105 includes a contact portion and an extending portion 105b. At least a part of the contact portion protrudes toward the outer surface of the base body 104a to be in contact with the coupling portion 104b2 to form an electrical connection. The extending portion 105b extends toward a position away from the base body 104a relative to the contact portion, and the extending portion 105b is configured to couple the battery cell 30.

The contact portion includes a body 105a and four arms 105a1 formed on the body 105a in a hollow-out manner. When the four arms 105a1 abut against the coupling portion 104b2, an elastic force can be generated to realize the electrical connection to the coupling portion 104b2; and the extending portion 105b extends from the body 105a toward the position away from the base body 104a.

The body 105a matches a shape of an end portion of the base body 104a. Specifically, the body 105a is formed in an arc shape, and the body 105a is provided with an abutting portion 105a2 extending radially. The arc-shaped body 105a is closely attached to a surface of the end portion of the base body 104a, and the abutting portion 105a2 abuts against the end portion of the base body 104a for position limiting, which is used to limit a relative position between the contact portion and the base body 104a, so that the arm 105a1 is positioned at the coupling portion 104b2.

The four arms 105a1 are spaced apart on the body 105a in the circumferential direction of the base body 104a. In another example, a quantity of arms 105a1 is not limited, and may be more than four or less. It can be understood that a plurality of arms 105a1 are helpful for reliable electrical connection to the electrode, but increase the processing cost. Those skilled in the art can choose according to needs.

The upper fixing base 101 is configured to fix the near end A of the base body 104a, and the upper sealing member 102 is arranged between the upper fixing base 101 and the near end A. The lower fixing base 110 is configured to fix the far end B of the base body 104a, and the lower sealing member 106 is arranged between the lower fixing base 110 and the far end B The sealing ring 108 is sleeved over the lower fixing base 110. The lower fixing base 110 and the base 111 are fastened by the fastener 107. Each of the upper fixing base 101 and the lower fixing base 110 is made of an electricity insulation, high temperature resistant, and heat insulation material. The sleeve pipe 103 is sleeved over the heater 104, and has one end abutting against the upper fixing base 101 and the other end abutting against the lower fixing base 110.

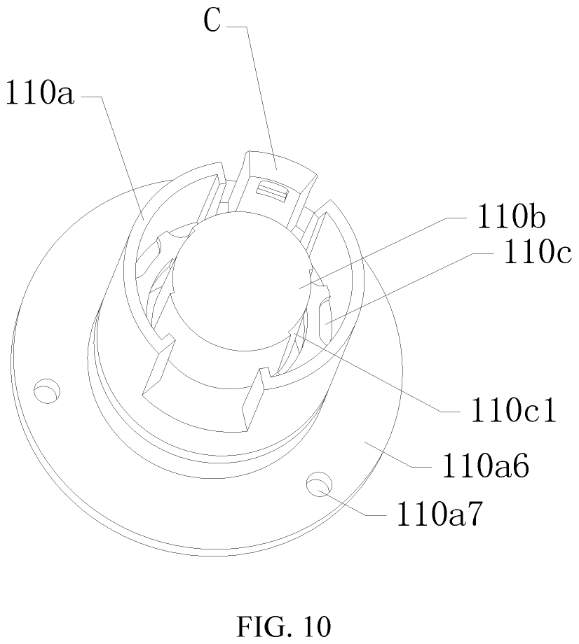

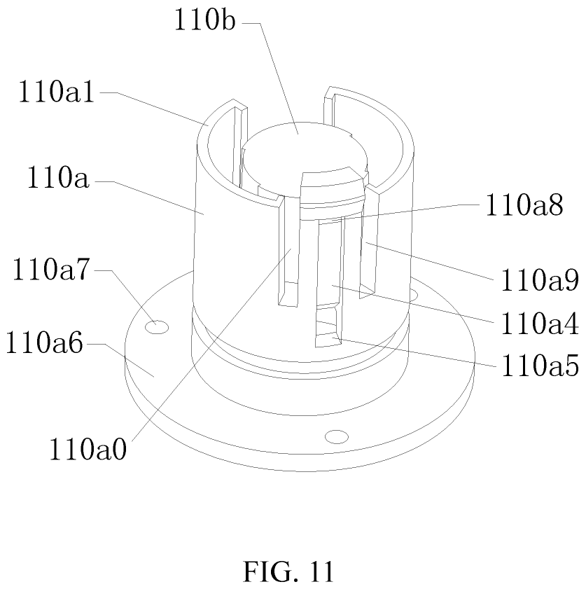

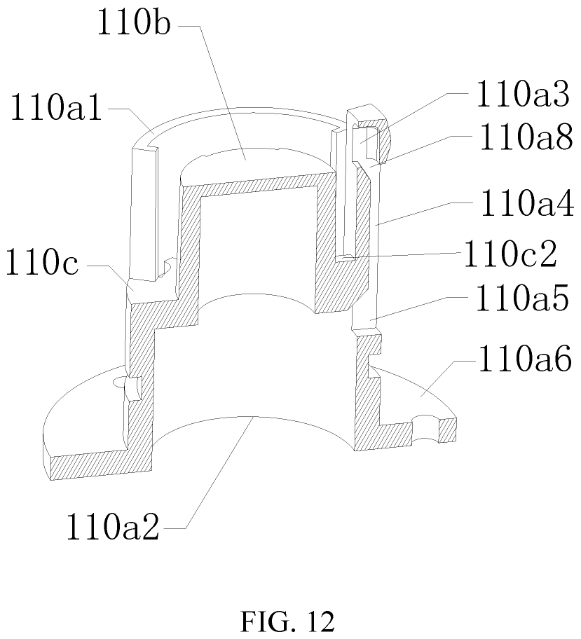

Referring to FIG. 10 to FIG. 13, the lower fixing base 110 includes an outer cylinder 110a, an inner cylinder 110b, and an extending portion 110c extending from an outer surface of the inner cylinder 110b to an inner surface of the outer cylinder 110a. The far end B of the base body 104a is arranged between the outer surface of the inner cylinder 110b and the inner surface of the outer cylinder 110a and held on the extending portion 110c.

The inner cylinder 110b is roughly in a shape of a hollow tube, with one end closed and the other end open, and an airflow flows in from the open end. The extending portion 110c extends from the open end of the inner cylinder 110b to the inner surface of the outer cylinder 110a. A length of the inner cylinder 110b in the axial direction is less than a length of the outer cylinder 110a in the axial direction. It should be noted that, in another example, both of the two ends of the inner cylinder 110b may be open, and the airflow may flow in from the lower open end and flow out from the upper open end.

The outer cylinder 110a is provided with a first end 110a1 and a second end 110a2 opposite to the first end 110a1. The far end B of the base body 104a is inserted between the outer surface of the inner cylinder 110b and the inner surface of the outer cylinder 110a in an extending direction from the first end 110a1 to the second end 110a2.

The outer cylinder 110a is further provided with a support portion C configured to hold the temperature measuring element 109, to enable the temperature measuring element 109 to be close to or in contact with a preset position on the outer surface of the base body 104a. The support portion C is formed by a part of the outer cylinder 110a and extends axially along the base body 104a, to enable a preset position of the temperature measuring element 109 positioned on the outer surface of the base body 104a to be between two ends of the base body 104a.

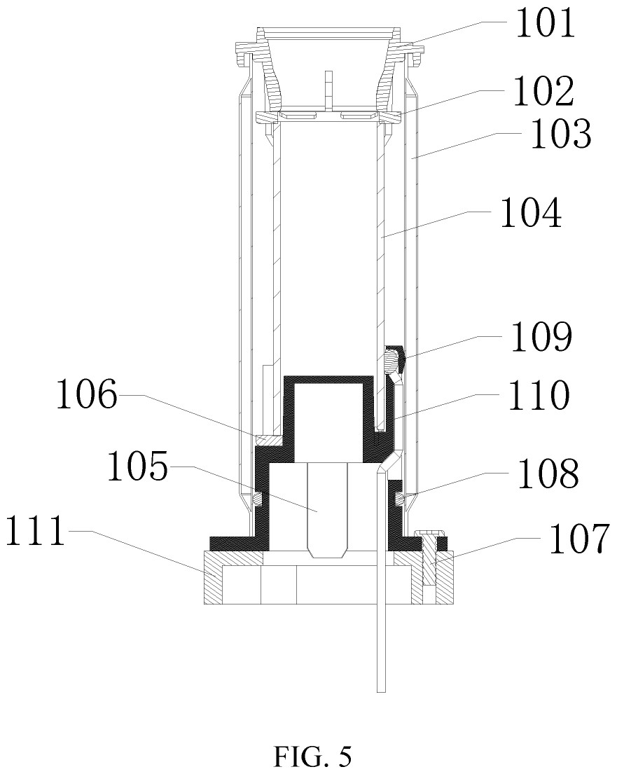

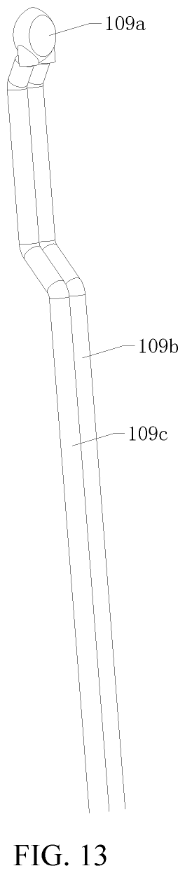

The support portion C includes an accommodating portion 110a3, and the accommodating portion 110a3 is arranged close to the first end 110a1. The accommodating portion 110a3 is located upstream of an end of the inner cylinder 110b close to the second end 110a2, that is, the accommodating portion 110a3 is located above the closed end of the inner cylinder 110b. The accommodating portion 110a3 is formed by recessing a part of the inner surface of the support portion C. Understanding is performed with reference to FIG. 5 and FIG. 13. The temperature measuring element 109 configured to sense the temperature of the heater 104 includes a body 109a, and a leading wire 109b and a leading wire 109c that are electrically connected to the body 109a. The body 109a is accommodated in the accommodating portion 110a3, to enable the body 109a to be close to or in contact with the preset position on the surface of the heater 104, that is, the preset position on the outer surface of the base body 104a. The accommodating portion 110a3 accommodates the temperature measuring element 109, which can ensure the stability of the position of the temperature measuring element 109, improve the reliability and consistency of temperature data collection, and facilitate effective control of the cigarette device 100.

Further, there are a first gap groove 110a0 and a second gap groove 110a9 extending axially and spaced apart in the circumferential direction of the outer cylinder 110a, and the support portion C is formed between the first gap groove 110a0 and the second gap groove 110a9, thereby forming an arm structure. Each of the first gap groove 110a0 and the second gap groove 110a9 is formed by recessing a part of an end face of the first end 110a1 toward the second end 110a2. By setting the gap grooves, a material can be saved and the support portion C can be deformed under the extrusion of surrounding components (such as the external sleeve pipe 103), thereby enabling the body 109a accommodated in the accommodating portion 110a3 to be closer to or in contact with the preset position on the surface of the heater 104.

The support portion C further includes a groove 110a4 formed on an outer surface of the support portion C, a connection hole 110a8 that connects the groove 110a4 to the accommodating portion 110a3, and a through hole 110a5 that is in communication with the groove 110a4. The connection hole 110a8 and the through hole 110a5 both pass through the inner surface and the outer surface of the support portion C. A part of an inner wall of the connection hole 110a8 is inclined to the axial direction of the outer cylinder 110a (an angle between the two is an obtuse angle), and the through hole 110a5 is arranged below the open end of the inner cylinder 110b or the extending portion 110c. When the body 109a is accommodated in the accommodating portion 110a3, the leading wire 109b and the leading wire 109c are threaded through the connection hole 110a8, the groove 110a4, and the through hole 110a5 in sequence, and extend from the second end 110a2 to the outside of the lower fixing base 110. A part of the leading wire 109b and a part of the leading wire 109c are both accommodated in the connection hole 110a8, the groove 110a4, and the through hole 110a5. In this way, the leading wire 109b or the leading wire 109c can be prevented from being close to or in contact with the heater 104.

The second end 110a2 of the outer cylinder 110a is further provided with a flange 110a6, and an end of the sleeve pipe 103 abuts against the flange 110a6. The sleeve pipe 103 is constructed to reduce radial heat radiation from the heater 104, which can be achieved by arranging a heat insulation material in the sleeve pipe 103, by vacuumizing, or by enclosing the air. This is not specifically limited herein. The flange 110a6 is provided with a fixing hole 110a7 configured to fix the lower fixing base 110. In this way, the lower fixing base 110 can be fastened to the base 111 through the fixing hole 110a7 and the fastener 107. The base 111 may be a separate structural component or a part of the housing assembly 50. This is not specifically limited herein.

The extending portion 110c is provided with a via hole 110cl; and the extending portion 105b of the electrode connector can be threaded through the via hole 110cl and extend along the inner surface of the outer cylinder 110a.

The extending portion is further provided with a convex pillar 110c2, and the far end B of the base body 104a is provided with a notch 104a3. The convex pillar 110c2 matches the notch 104a3 to limit a position of the far end B of the base body 104a and prevent the far end B of the base body 104a from rotating circumferentially.

An assembly process of the heating assembly 10 is roughly as follows:
Step 1: Assemble a lower sealing member 106 and two electrode connectors 105 in a lower fixing base 110, that is, an extending portion 105b of the electrode connector 105 is threaded through a via hole 110cl, and the lower sealing member 106 is placed on an extending portion 110c, thereby forming an assembly 1.
Step 2: Fix the assembly 1 on a base 111 through a fastener 107 (such as a screw), and then sleeve a sealing ring 108 over the lower fixing base 110, thereby forming an assembly 2.
Step 3: Assemble an upper sealing member 102 into an upper fixing base 101, and assemble the upper fixing base 101 and a sleeve pipe 103 in an interference fit, thereby forming an assembly 3.
Step 4: Insert a far end B of a base body 104a into the lower fixing base 110 in the assembly 2, thereby forming an assembly 4.
Step 5: Assemble the assembly 3 and the assembly 4 together to complete assembly of the heating assembly 10.

When the base body 104a needs to be replaced, it is only necessary to disassemble the assembly 3, take out the base body 104a, insert a new base body 104a, and then assemble the assembly 3 and the assembly 4 together.

It can be seen from the above that when assembling and replacing the base body 104a, there are fewer processes and the efficiency is higher.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1: A heating assembly, comprising:
a heater, configured to heat an aerosol-forming substrate to generate an aerosol;
a temperature measuring element, configured to sense a temperature of the heater; and
a fixing base, configured to fix an end of the heater, wherein the fixing base comprises a support portion, and the support portion is configured to hold the temperature measuring element, to enable the temperature measuring element to be close to or in contact with a preset position on a surface of the heater.

2: The heating assembly according to claim 1, wherein the support portion extends axially along the heater, to enable a preset position of the temperature measuring element positioned on the surface of the heater to be between two ends of the heater.

3: The heating assembly according to claim 1, wherein the support portion is constructed into an arm structure relative to other portions of the fixing base.

4: The heating assembly according to claim 1, wherein the support portion comprises an accommodating portion, and the accommodating portion is configured to receive at least a part of the temperature measuring element.

5: The heating assembly according to claim 4, wherein the accommodating portion is arranged close to an end portion of the support portion.

6: The heating assembly according to claim 4, wherein the support portion comprises a first surface facing the heater and a second surface opposite to the first surface; and
the accommodating portion is formed by recessing at least a part of the first surface.

7: The heating assembly according to claim 6, wherein the support portion further comprises a groove formed on the second surface and a connection hole that connects the groove to the accommodating portion; and
the temperature measuring element is provided with a leading wire, and at least a part of the leading wire is accommodated in the groove and the connection hole.

8: The heating assembly according to claim 7, wherein the support portion further comprises a through hole, and the leading wire is configured to be threaded through the through hole and then extend from the inside of the fixing base to the outside of the fixing base.

9: The heating assembly according to claim 8, wherein the through hole is in communication with the groove.

10: The heating assembly according to claim 1, wherein the fixing base comprises an outer cylinder sleeved over the end of the heater, and the support portion is formed by at least a part of the outer cylinder.

11: The heating assembly according to claim 10, wherein the fixing base comprises an inner cylinder and an extending portion extending from the inner cylinder to the outer cylinder; and the end of the heater is arranged between the inner cylinder and the outer cylinder and held on the extending portion.

12: The heating assembly according to claim 11, wherein the extending portion is provided with a via hole; and
the heating assembly further comprises an electrode connector configured to be electrically connected to the heater, and an end of the electrode connector is configured to be threaded through the via hole and extend toward the outside of the fixing base.

13: The heating assembly according to claim 11, wherein the extending portion is provided with a convex pillar, and the end of the heater is provided with a notch; and
the convex pillar matches the notch to limit a position of the heater.

14: The heating assembly according to claim 1, wherein an end of the fixing base is provided with a flange, and the flange is provided with a fixing hole configured to fix the fixing base.

15: The heating assembly according to claim 1, wherein the heater comprises a base body, an electrode, and an electric infrared heating layer formed on the base body; and
the electrode comprises a first electrode and a second electrode, and the first electrode and the second electrode are connected to the electric infrared heating layer through an electric wire.

16: The heating assembly according to claim 15, wherein the electrode further comprises a third electrode connected to the electric infrared heating layer through an electric wire, and the first electrode, the second electrode, and the third electrode are configured to partition the electric infrared heating layer into two heating regions, to heat different regions of the aerosol-forming substrate.

17: The heating assembly according to claim 1, wherein the heating assembly further comprises a sleeve pipe peripherally surrounding the heater, and the support portion is clamped between the sleeve pipe and the heater.

18: The heating assembly according to claim 17, wherein the sleeve pipe is constructed to reduce radial heat radiation from the heater.

19: A cigarette device, comprising the heating assembly according to claim 1.
